(19) United States
(12) Patent Application Publication
(10) Pub. No.: US 2004/0066248 A1
(43) Pub. Date: Apr. 8, 2004

(54) Miniature non-reciprocal circuit element with little variation in input impedance and communication apparatus

(75) Inventor: Eiichi Komai, Niigate-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/672,116

(22) Filed: Sep. 26, 2003

(30) Foreign Application Priority Data
Oct. 2, 2002 (JP) 2002-289694

(51) Int. Cl. H01P 1/36; H01P 1/32

(52) U.S. Cl. 333/24.2; 333/1.1

(57) ABSTRACT

In a non-reciprocal circuit element according to the present invention, a common electrode is disposed on one surface of a plate-like magnetic material, three central conductors protruding in respective directions from the periphery of the common electrode are folded over the other surface of the plate-like magnetic material so as to wrap around the plate-like magnetic material, and the central conductors cross each other at a predetermined angle on the other surface of the plate-like magnetic material. One of the central conductors that functions as an input is disposed in a position closer to the other surface of the plate-like magnetic material as compared with the other central conductors and directly contacts the plate-like magnetic material.

### BACKGROUND OF THE INVENTION

1. Field of the Invention

The present invention relates to a non-reciprocal circuit element and a communication apparatus, and more particularly to a non-reciprocal circuit element in which variation in input impedance is reduced.

2. Description of the Related Art

Lumped-constant isolators are high-frequency components having functions to make signals pass in a transmission direction without loss and to prevent signals from passing in the opposite direction. The lumped-constant isolators are used by being disposed between an antenna and a transmitting circuit part of mobile communication apparatuses, such as cellular telephones. More specifically, a transmitting circuit part is connected to an input terminal of an isolator and an antenna is connected to an output terminal of the isolator.

In order to improve the communication performance of cellular telephones, it is important to match the impedance between a transmitting circuit part and an antenna. Thus, the input impedance of an isolator disposed between the transmitting circuit part and the antenna is needed to be reduced.

Related art documents relating to isolators are, for example, Japanese Unexamined Patent Application Publication Nos. 6-19607 and 2001-284910

Development of cellular telephones has been made with emphasis on impedance matching between a transmitting circuit part and an antenna due to a relatively large size of isolators, such as 7 mm or 5 mm square, and due to flexibility in designing. Also, as is clear from the absence of a description about the input impedance of isolators in the above-mentioned related art documents, the input impedance of isolators has not received much attention, and each component has not been designed in accordance with specific dimensions of isolators.

Recently, however, since isolators with a further reduced size, such as 4 mm square or less, are required due to a reduction in the size of cellular telephones, there is a tendency for variation in the input impedance to become significant in accordance with the reduction in the size of isolators. Thus, high assembly accuracy and quality stabilization of miniature isolators are becoming more important.

### SUMMARY OF THE INVENTION

The present invention is designed with respect to the above-mentioned circumstances and an object of the present invention is to provide a miniature non-reciprocal circuit element in which variation in input impedance is reduced and to provide a communication apparatus with excellent communication performance.

In order to achieve the above object, the present invention adopts the following arrangement.

In a non-reciprocal circuit element according to the present invention, a common electrode is disposed on one surface of a plate-like magnetic material, three central conductors protruding in respective directions from the periphery of the common electrode are folded over the other surface of the plate-like magnetic material so as to wrap around the plate-like magnetic material, and the central conductors cross each other at a predetermined angle on the other surface of the plate-like magnetic material. One of the central conductors that functions as an input is disposed in a position closer to the other surface of the plate-like magnetic material as compared with the other central conductors and directly contacts the plate-like magnetic material.

Preferably, the central conductor functioning as the input closely contacts the other surface of the plate-like magnetic material.

According to the non-reciprocal circuit element of the present invention, since the central conductor functioning as the input is disposed in a position closer to the plate-like magnetic material as compared with the other central conductors and directly contacts the plate-like magnetic material, there is no possibility of causing a space between the central conductor functioning as the input and the plate-like magnetic material. Thus, variation in the inductance of the central conductor functioning as the input can be reduced and thus variation in the input impedance of the non-reciprocal circuit element can be suppressed.

The plate-like magnetic material, the common electrode, and the central conductors may be contained in a hollow yoke of an approximately rectangular parallelepiped made of soft magnetic materials, and at least two sides defining the hollow yoke may be each 4 mm or less.

The non-reciprocal circuit element according to the present invention includes a hollow yoke of an approximately rectangular parallelepiped of 4 mm square or less. In such a miniature non-reciprocal circuit element, the arrangement in which the central conductor functioning as the input closely contacts the plate-like magnetic material effectively reduces the variation in the inductance of the central conductor functioning as the input and thus further suppresses the variation in the input impedance of the non-reciprocal circuit element.

One of the central conductors that functions as an output may be disposed on the central conductor functioning as the input on the other surface of the plate-like magnetic material.

In the non-reciprocal circuit element according to the present invention, the central conductor functioning as the output is disposed on the central conductor functioning as the input and thus the central conductor functioning as the output is located close to the plate-like magnetic material. Thus, the inductance of the central conductor functioning as the output is increased and this is advantageous in reducing the size of the non-reciprocal circuit element. Moreover, variation in the inductance is reduced and thus variation in the output impedance can be suppressed.

A length of an overlap portion of the central conductor functioning as the input and the central conductor functioning as the output in an intersection of the central conductor functioning as the input and the central conductor functioning as the output may be 10% or more of a length of portions of the central conductors disposed on the other surface of the plate-like magnetic material.

Since the length of the overlap portion of the central conductor functioning as the input and the central conductor functioning as the output in the intersection of the central conductor functioning as the input and the central conductor functioning as the output is set as described above, the capacitance secured in the overlap portion of the central conductors increases in accordance with an increase in the length of the overlap portion. Thus, the inductances of the central conductors can be reduced, in other words, the conductor lengths of the central conductors can be reduced. Therefore, it is advantageous in reducing the size of the non-reciprocal circuit element.

The central conductor functioning as the input and the central conductor functioning as the output may be connected to a matching capacitor, and the other central conductor may be connected to a matching capacitor and a terminating resistor.

The non-reciprocal circuit element transmits signals from the input to the output without loss and prevents signals from passing in the opposite direction. Thus, the non-reciprocal circuit element is suitable for mobile communication apparatuses such as cellular telephones. Also, with the non-reciprocal circuit element having the arrangement described above, variation in the input impedance can be reduced.

A communication apparatus according to the present invention includes any one of the non-reciprocal circuit element described above, a transmitting circuit part connected to the central conductor functioning as the input of the non-reciprocal circuit element, and an antenna connected to the central conductor functioning as the output of the non-reciprocal circuit element.

Since the communication apparatus according to the present invention is provided with the non-reciprocal circuit element exhibiting stable input impedance, the impedance between the transmitting circuit part and the antenna can be easily matched. Thus, the communication performance of the communication apparatus can be improved.

### BRIEF DESCRIPTION OF THE DRAWINGS

FIG. 1A is a plan view showing a state when a part of an isolator according to a first embodiment of the present invention is removed;

FIG. 1B is a cross-sectional view of the isolator according to the first embodiment of the present invention;

FIG. 2 is a plan view showing an example of a magnetic material used for the isolator according to the present invention;

FIG. 3 is a developed view of an electrode unit used for the isolator according to the present invention;

FIG. 4A is an illustration showing an example of an electric circuit provided with an isolator of this type;

FIG. 4B is an illustration showing the principle of operation of the isolator;

FIG. 5 is an illustration showing a second example of the electrode unit of the isolator according to the present invention;

FIG. 6 is an illustration showing a third example of the electrode unit of the isolator according to the present invention;

FIG. 7 is an exploded perspective view showing an isolator according to another embodiment of the present invention;

FIG. 8 is a graph showing measurement results of the impedances of isolators according to examples 1 to 5 at each frequency; and

FIG. 9 is a graph showing measurement results of the impedances of isolators according to examples 6 to 10 at each frequency.

### DESCRIPTION OF THE PREFERRED EMBODIMENTS

Embodiments of the present invention will be described with reference to the drawings.

### First Embodiment

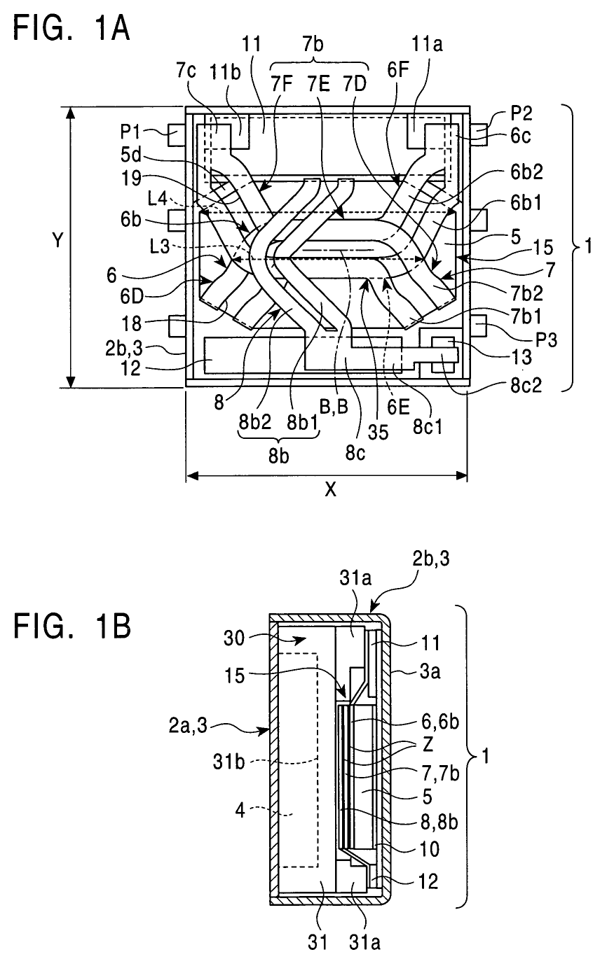

FIGS. 1A to 3 show a non-reciprocal circuit element applied to an isolator 1 according to a first embodiment of the present invention.

The isolator 1 according to the first embodiment includes a hollow yoke 3 composed of an upper yoke 2a and a lower yoke 2b. The hollow yoke 3 contains a magnetic member 4 made of a permanent magnet or the like, a plate-like magnetic material 5, a first line conductor 6, a second line conductor 7, and a third line conductor 8. The hollow yoke 3 also contains a common electrode 10, matching capacitors 11 and 12, and a terminating resistor 13. The common electrode 10 is connected to the first line conductor 6, the second line conductor 7, and the third line conductor 8. The matching capacitors 11 and 12 and the terminating resistor 13 are arranged around the plate-like magnetic material 5.

The upper yoke 2a and the lower yoke 2b are made of ferromagnetic materials such as soft iron and are assembled to constitute the rectangular parallelepiped-shaped hollow yoke 3. Here, it is preferable that conductive layers such as silver coating be coated over the front and rear surfaces of the upper yoke 2a and the lower yoke 2b. Also, the upper yoke 2a having a U-shaped side face has a size that can be received in the lower yoke 2b having a U-shaped side face. Open parts of the upper yoke 2a and the lower yoke 2b are fitted together in order to form a box-type closed magnetic circuit composed of the integrated upper yoke 2a and lower yoke 2b.

The upper yoke 2a and the lower yoke 2b are not necessarily U-shaped as in the first embodiment. The upper yoke 2a and the lower yoke 2b may be of any shape as long as a plurality of yokes constitutes a box-type closed magnetic circuit.

Also, it is preferable that at least two sides of the hollow yoke 3 be each 4 mm or less. In other words, as shown in FIG. 1A, it is preferable that a horizontal dimension X and a vertical dimension Y be each 4 mm or less, that is 4 mm square or less, when viewed in plan. Isolators of such small size are suitable for miniature and light-weight mobile communication apparatuses such as cellular telephones.

A magnetic assembly 15 including the plate-like magnetic material 5, the first line conductor 6, the second line conductor 7, the third line conductor 8, and the common electrode 10 connected to the first line conductor 6, the second line conductor 7, and the third line conductor 8 is contained in a space surrounded by the lower yoke 2b and the upper yoke 2a fitted together as described above, in other words, within the hollow yoke 3. Accordingly, the isolator 1 according to the first embodiment includes the magnetic assembly 15.

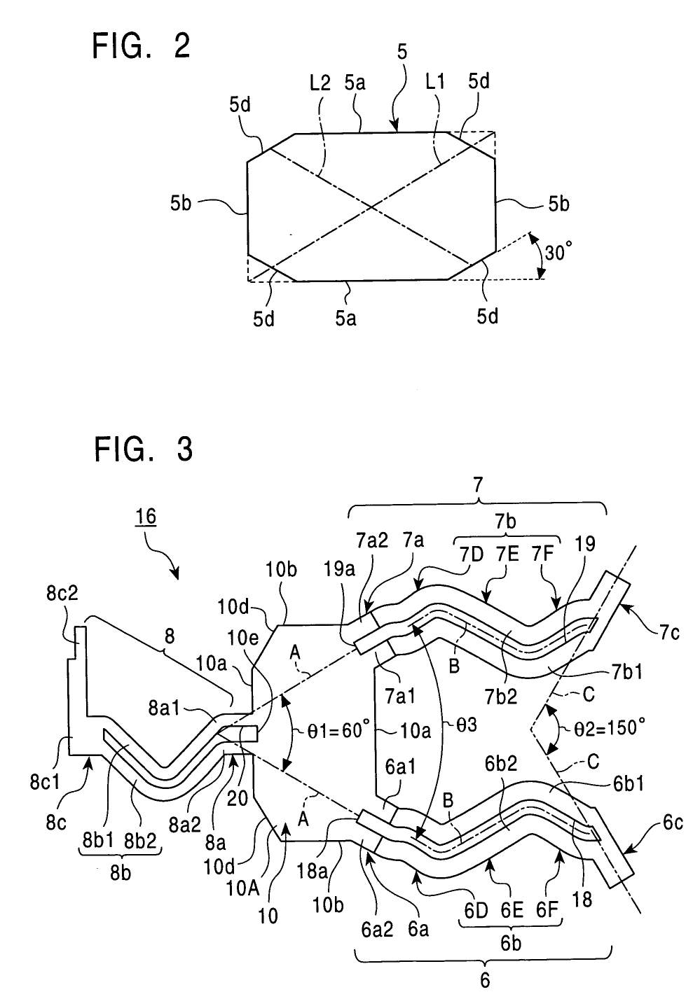

The plate-like magnetic material 5 is made of ferromagnetic materials such as ferrite and may be of any shape, such as a circular or rectangular shape, as necessary. In the first embodiment, as shown in FIG. 2, the plate-like magnetic material 5 has a substantially horizontally-long rectangular plate shape when viewed in plan. More specifically, the plate-like magnetic material 5 that has a substantially horizontally-long rectangular plate shape when viewed in plan includes two opposing longer sides 5a, two opposing shorter sides 5b that are perpendicular to the longer sides 5a, and four inclined sides 5d that are located at ends of the longer sides 5a and are also connected to the shorter sides 5b. The inclined sides 5d are inclined at 150 degrees to the longer sides 5a (inclined at 30 degrees to extensions of the longer sides 5a). Thus, the four corners of the plate-like magnetic material 5 when viewed in plan have inclined sides (abutments) 5d that are inclined at 150 degrees to the longer sides 5a and at 120 degrees to the shorter sides 5b.

The first line conductor 6, the second line conductor 7, the third line conductor 8, and the common electrode 10 are integrated together, as shown in FIG. 3. An electrode unit 16 mainly includes the first line conductor 6, the second line conductor 7, the third line conductor 8, and the common electrode 10. The common electrode 10 includes a main part 10A made of a metal plate having a shape approximately similar to the plate-like magnetic material 5 when viewed in plan. In other words, the main part 10A that is approximately rectangular when viewed in plan includes two opposing longer-side parts 10a, two opposing shorter-side parts 10b that are perpendicular to the longer-side parts 10a, and inclined parts 10d located at ends of the longer-side parts 10a and connected to the shorter-side parts 10b. The inclined parts 10d are inclined at 150 degrees to the longer-side parts 10a and are connected to the shorter-side parts 10b at an inclination of 120 degrees.

The first line conductor 6 and the second line conductor 7 protrude from the common electrode 10. The first line conductor 6 includes a first base conductor 6a, a first central conductor 6b, and a first front-end conductor 6c and protrudes from one end of one of the longer-side parts 10a of the common electrode 10. The second line conductor 7 includes a second base conductor 7a, a second central conductor 7b, and a second front-end conductor 7c and protrudes from the other end of the one of the longer-side parts 10a of the common electrode 10.

An angle θ1 between central axis lines A of the first base conductor 6a and the second base conductor 7a is set to approximately 60 degrees, as shown in FIG. 3.

Also, the first central conductor 6b functions as an input side central conductor and the second central conductor 7b functions as an output side central conductor.

The first central conductor 6b is zigzag or waved when viewed in plan and includes a first base conductor side part 6D, a first front-end conductor side part 6F, and a first central part 6E arranged between the first base conductor side part 6D and the first front-end conductor side part 6F. The second central conductor 7b has a shape similar to the first central conductor 6b and includes a second base conductor side part 7D, a second front-end conductor side part 7F, and a second central part 7E arranged between the second base conductor side part 7D and the second front-end conductor side part 7F. Arranging the first central conductor 6b and the second central conductor 7b in such shapes increases the conductor lengths of the first central conductor 6b and the second central conductor 7b and thus increases the inductances thereof. Thus, the frequency and the size of the non-reciprocal circuit element can be reduced at the same time. Also, increasing the inductances of the first central conductor 6b and the second central conductor 7b causes the capacitance of a capacitor connected to the first line conductor 6 and the second line conductor 7 to be relatively reduced, thus enabling the size of the isolator 1 to be reduced.

The first base conductor side part 6D and the second base conductor side part 7D are arranged such that an angle θ3 between central axis lines B of the first base conductor side part 6D and the second base conductor side part 7D is larger than or equal to the above-mentioned angle θ1, as shown in FIG. 3. In other words, the angle θ3 is set such that the first base conductor side part 6D and the second base conductor side part 7D gradually diverge from each other.

The first central part 6E and the second central part 7E are arranged such that the central axis lines B of the first central part 6E and the second central part 7E gradually converge together, as shown in FIG. 3.

The first front-end conductor side part 6F and the second front-end conductor side part 7F are arranged such that the angle θ3 between the central axis lines B of the first front-end conductor side part 6F and the second front-end conductor side part 7F is larger than the above-mentioned angle θ1, as shown in FIG. 3. In other words, the angle θ3 is set such that the first front-end conductor side part 6F and the second front-end conductor side part 7F gradually diverge from each other.

Moreover, the first front-end conductor 6c and the second front-end conductor 7c are arranged such that an angle θ2 between central axis lines C of the first front-end conductor 6c and the second front-end conductor 7c is approximately 150 degrees or more. In other words, the angle θ2 is set such that the first front-end conductor 6c and the second front-end conductor 7c gradually diverge from each other.

A slit 18 is provided at the center in the width direction of the first line conductor 6 in such a manner that the slit 18 is arranged in an area from the periphery of the common electrode 10 to a base end of the first front-end conductor 6c through the first base conductor 6a and the first central conductor 6b. The slit 18 separates the first central conductor 6b into conductor segments 6b l and 6b 2 and also separates the first base conductor 6a into conductor segments 6a l and 6a2.

A slit 19 that is similar to the slit 18 is provided at the center in the width direction of the second line conductor 7. The slit 19 separates the second central conductor 7b into conductor segments 7b l and 7b 2 and also separates the second base conductor 7a into conductor segments 7a1 and 7a2.

One end of the slit 18 on the common electrode 10 side passes through the first base conductor 6a and reaches a slightly deep point from the periphery of the common electrode 10 to form a recessed part 18a, so that the line length of the first line conductor 6 is made slightly longer. Also, one end of the slit 19 on the common electrode 10 side passes through the second base conductor 7a and reaches the periphery of the common electrode 10 to form a recessed part 19a, so that the line length of the second line conductor 7 is made slightly longer. Here, the recessed parts 18a and 19a are not necessarily provided. The recessed parts 18a and 19a may be provided as necessary.

The third line conductor 8 protrudes from the center of the other of the longer-side parts 10a of the common electrode 10. The third line conductor 8 includes a third base conductor 8a, a third central conductor 8b, and a third front-end conductor 8c. The third base conductor 8a includes rectangular conductor segments 8a l and 8a 2 separated by a slit 20 and the conductor segments 8a l and 8a 2 protrude approximately perpendicular from the center of the other of the longer-side parts 10a of the common electrode 10.

The third central conductor 8b is bent in the shape of an L when viewed in plan. The third central conductor 8b includes a conductor segment 8b1 of the L shape when viewed in plan and a conductor segment 8b2 of the L shape when viewed in plan. The conductor segment 8b1 is connected to the conductor segment 8a 1 and the conductor segment 8b2 is connected to the conductor segment 8a2. Bending the third central conductor 8b as described above increases the actual conductor length of the third central conductor 8b and thus increases the inductance thereof. Thus, the frequency and the size of the non-reciprocal circuit element can be reduced at the same time.

Moreover, front ends of the conductor segments 8b1 and 8b2 are integrated with the L-shape third front-end conductor 8c. The third front-end conductor 8c includes a connection part 8c1 a connection part 8c2. The connection part 8c1 is integrated with the conductor segments 8b1 and 8b 2 and protrudes in the same direction as the conductor segments 8a1 and 8a2 protruding from the common electrode 10. The connection part 8c2 protrudes approximately perpendicular from the connection part 8c1.

A recessed part 10e is provided in a portion between the conductor segments 8a1 and 8a2 of the third line conductor 8 at the other of the longer-side parts 10a of the common electrode 10 by cutting out part of the other of the longer-side parts 10a of the common electrode 10. Arranging the recessed part 10e slightly increases the line length of the third line conductor 8. Here, the recessed part 10e may be provided as necessary, as in the recessed parts 18a and 19a.

The main part 10A of the common electrode 10 is attached to a rear surface (one surface) of the plate-like magnetic material 5. The first line conductor 6, the second line conductor 7, and the third line conductor 8 are folded over a front surface (the other surface) of the plate-like magnetic material 5. Accordingly, the electrode unit 16 arranged as described above is mounted on the plate-like magnetic material 5, and the electrode unit 16 and the plate-like magnetic material 5 constitute the magnetic assembly 15.

In other words, the conductor segments 6a1 and 6a2 of the first line conductor 6 are folded along the edge of one of the inclined sides 5d of the plate-like magnetic material 5, the conductor segments 7a1 and 7a2 of the second line conductor 7 are folded along the edge of another of the inclined side 5d of the plate-like magnetic material 5, and the conductor segments 8a1 and 8a2 of the third line conductor 8 are folded along the edge of one of the longer sides 5a of the plate-like magnetic material 5. Also, the first central conductor 6b of the first line conductor 6 is attached along the front surface (the other surface) of the plate-like magnetic material 5, the second central conductor 7b of the second line conductor 7 is attached along the front surface (the other surface) of the plate-like magnetic material 5, and the third central conductor 8b of the third line conductor 8 is attached along a central portion of the front surface of the plate-like magnetic material 5. Accordingly, the electrode unit 16 is mounted on the plate-like magnetic material 5, and the electrode unit 16 and the plate-like magnetic material 5 constitute the magnetic assembly 15.

The first central conductor 6b and the second central conductor 7b attached along the front surface (the other surface) of the plate-like magnetic material 5 as described above cross each other on the front surface of the plate-like magnetic material 5. FIGS. 1A and 1B show a case where the first central part 6E overlaps the second central part 7E.

In this case, as shown in FIGS. 1A and 1B, the first central conductor 6b (input side central conductor) is disposed closer to the plate-like magnetic material 5 as compared with the second central conductor 7b (output side central conductor) in such a manner that the first central conductor 6b directly contacts the other surface of the plate-like magnetic material 5. With this arrangement, there is no space between the first central conductor 6b and the plate-like magnetic material 5. Thus, variation in the inductance of the first central conductor 6b is reduced and thus variation in the input impedance of the isolator 1 can be suppressed.

It is preferable that the second central conductor 7b (output side central conductor) be disposed on the first central conductor 6b with an insulation sheet Z therebetween. It is also preferable that the third central conductor 8b be disposed on the second central conductor 7b with the insulation sheet Z therebetween. Accordingly, the first central conductor 6b, the second central conductor 7b, and the third central conductor 8b can be electrically insulated from each other.

Also, disposing the second central conductor 7b on the first central conductor 6b causes the second central conductor 7b to be located close to the plate-like magnetic material 5, thus increasing the inductance of the second central conductor 7b. Therefore, it is advantageous in reducing the size of the isolator 1. Moreover, variation in the inductance is reduced and thus variation in the output impedance can be suppressed.

Also, as shown in FIG. 1A, a length L3, which is a length of a portion where the first central conductor 6b overlaps the second central conductor 7b in an intersection 35 of the first central conductor 6b and the second central conductor 7b, is 10% or more of a length L4, which is a length of portions of the first central conductor 6b and the second central conductor 7b that are disposed on the front surface (the other surface) of the plate-like magnetic material 5, more preferably, 20% or more of the length L4. FIG. 1A shows a case where the length L3, which is a length of the overlap portion of the first central conductor 6b and the second central conductor 7b in the intersection 35, is approximately 75% of the length L4, which is a length of portions of the first central conductor 6b and the second central conductor 7b that are disposed on the front surface of the plate-like magnetic material 5.

The length L3, which is a length of the overlap portion of the first central conductor 6b and the second central conductor 7b, may be increased to be equal to the length L4, which is a length of portions of the first central conductor 6b and the second central conductor 7b that are disposed on the front surface of the plate-like magnetic material 5, by changing the shapes or the like of the first line conductor 6 and the second line conductor 7. For example, the angle θ1 between the central axis lines A of the first base conductor 6a and the second base conductor 7a or the angle θ3 between the central axis lines B of the first central conductor 6b and the second central conductor 7b may be changed in order to change the length L3.

When the overlap portion of the first central conductor 6b and the second central conductor 7b cross each other, it is preferable that the crossing angle be 30 degrees or less, more preferably, 15 degrees or less.

Also, it is preferable that the first central conductor 6b and the second central conductor 7b in the overlap portion do not cross each other and that the first central conductor 6b be approximately parallel to the second central conductor 7b.

FIGS. 1A and 1B show a case where the central axis line B of the first central part 6E is parallel to the central axis line B of the second central part 7E.

Since the length L3, which is a length of the overlap portion of the first central conductor 6b and the second central conductor 7b in the intersection 35 is 10% or more of the length L4, which is a length of portions of the first central conductor 6b and the second central conductor 7b that are disposed on the front surface (the other surface) of the plate-like magnetic material 5, the capacitance secured in the overlap portion of the first central conductor 6b and the second central conductor 7b increases in accordance with an increase in the length L3. Thus, the inductances of the first central conductor 6b and the second central conductor 7b can be reduced, in other words, the conductor lengths of the first central conductor 6b and the second central conductor 7b can be reduced. Therefore, it is advantageous in reducing the size of the isolator 1.

The magnetic assembly 15 is arranged at the center of the bottom of the lower yoke 2b. The plate-like matching capacitors 11 and 12 are arranged on sides of the magnetic assembly 15 at the bottom of the lower yoke 2b and the terminating resistor 13 is arranged at one end of the matching capacitor 12. The matching capacitors 11 and 12 are rectangular plates when viewed in plan and the thicknesses thereof are approximately half that of the plate-like magnetic material 5.

The first front-end conductor 6c of the first line conductor 6 is electrically connected to an electrode part 11a arranged at one end of the matching capacitor 11, the second front-end conductor 7c of the second line conductor 7 is electrically connected to an electrode part 11b arranged at the other end of the matching capacitor 11, and the third front-end conductor 8c of the third line conductor 8 is electrically connected to the matching capacitor 12 and the terminating resistor 13. Accordingly, the magnetic assembly 15 is connected to the matching capacitors 11 and 12 and the terminating resistor 13. Here, in a case where the terminating resistor 13 is not connected, the non-reciprocal circuit element functions as a circulator.

A first port P1 of the isolator 1 is arranged near the end of the matching capacitor 11 that is connected to the second front-end conductor 7c, a second port P2 of the isolator 1 is arranged near the end of the matching capacitor 11 that is connected to the first front-end conductor 6c, and a third port P3 of the isolator 1 is arranged near the end of the terminating resistor 13 that is connected to the third front-end conductor 8c.

The magnetic assembly 15 has a thickness that accounts for approximately half the thickness of the space between the lower yoke 2b and the upper yoke 2a. A spacing member 30 shown in FIG. 1B is arranged in a space above the magnetic assembly 15 and near the upper yoke 2a. The magnetic member 4 is installed on the spacing member 30.

The spacing member 30 includes a substrate 31 and four legs 31a. The substrate 31 is a rectangular plate when viewed in plan and has a size that can be accommodated in the upper yoke 2a. The legs 31a are provided at four corners of the bottom of the substrate 31. A circular receiving recess 31b is provided on a surface (upper surface) of the substrate 31 on which the legs 31a are not provided. A rectangular clearance hole (not shown) that penetrates the substrate 31 is arranged at the bottom of the receiving recess 31b.

The magnetic member 4 made of a disk-like permanent magnet is received in the receiving recess 31b. The spacing member 30 provided with the magnetic member 4 presses the matching capacitors 11 and 12, the first front-end conductor 6c and the second front-end conductor 7c that are connected to the matching capacitors 11 and 12, the terminating resistor 13, and the third front-end conductor 8c that is connected to the terminating resistor 13 against the bottom of the lower yoke 2b using the legs 31a. The magnetic assembly 15 is pressed against the bottom of the lower yoke 2b with the bottom of the spacing member 30 to be accommodated between the upper yoke 2a and the lower yoke 2b.

The isolator 1 according to the first embodiment shown in FIGS. 1A to 3 includes the hollow yoke 3 of an outer size of 4 mm square containing the plate-like magnetic material 5, the first central conductor 6b, the second central conductor 7b, and the third central conductor 8b. Since the first central conductor 6b functioning as the input closely contacts the plate-like magnetic material 5, even when the isolator 1 is small such as 4 mm square, variation in the inductance of the first central conductor 6b functioning as the input is effectively reduced and thus variation in the input impedance of the isolator 1 can be suppressed.

Also, since the first line conductor 6 and the second line conductor 7 are folded over the front surface of the plate-like magnetic material 5, as described above, a signal input from the input side line conductor to the plate-like magnetic material 5 can be effectively transmitted to the output side line conductor, thus exhibiting low-loss and wide-band transmission characteristics. Accordingly, preferable magnetic characteristics of the magnetic assembly 15 can be ensured.

If the isolator 1 according to the first embodiment is installed on a cellular telephone used at a relatively low frequency, such as a frequency range of approximately 0.8 GHz to 0.9 GHz, a large inductance is required. In the first embodiment, since each of the line conductors is separated into two conductor segments by the slit provided in each of the line conductors, a larger inductance can be achieved due to a mutual inductance as compared with an unseparated line conductor with the same conductor length. Also, in the first embodiment, since a recessed part is provided at the end of each of the slits near the common electrode 10, the line length of each of the line conductors is slightly made longer, thus achieving a larger inductance. Therefore, the capacitances of the matching capacitors can be reduced, thus advantageously reducing the size of the isolator 1.

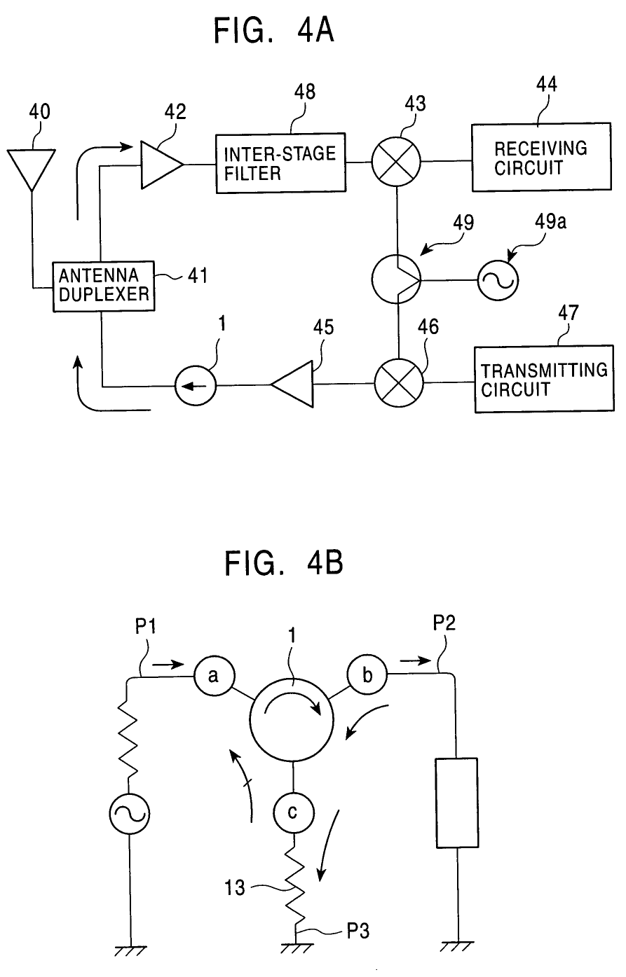

FIG. 4A shows an example of the circuit structure of a cellular telephone in which the isolator 1 according to the first embodiment is incorporated. In this circuit structure, an antenna 40 is connected to an antenna duplex 41. An output of the antenna duplex 41 is connected to a receiving circuit (IF circuit) 44, with a low-noise amplifier 42, an inter-stage filter 48, and a selection circuit (mixed circuit) 43 therebetween. An input of the antenna duplex 41 is connected to a transmitting circuit (IF circuit) 47, with the isolator 1 according to the first embodiment, a power amplifier 45, and a selection circuit (mixed circuit) 46 therebetween. The selection circuits 43 and 46 are connected to a local oscillator 49a with a distribution transformer 49 therebetween. Here, the first central conductor 6b functioning as the input of the isolator 1 is connected to the transmitting circuit 47 side and the second central conductor 7b functioning as the output of the isolator 1 is connected to the antenna 40 side.

The isolator 1 with the arrangement described above is used by being incorporated in the circuit of the cellular telephone shown in FIG. 4A. Although a signal is transmitted from the isolator 1 toward the antenna duplex 41 with low loss, a signal from the antenna duplex 41 toward the isolator 1 is blocked by increasing loss. Thus, unnecessary signals, such as noise of the power amplifier 45, are not input back to the power amplifier 45.

Also, since the input impedance of the isolator 1 described above is stable, the impedance between the transmitting circuit 47 and the antenna 40 can be easily matched, thus improving the communication performance of the cellular telephone.

FIG. 4B shows the principle of operation of the isolator 1 shown in FIGS. 1A to 3. The isolator 1 incorporated in the circuit shown in FIG. 4B transmits a signal from the first port P1 represented by a toward the second port P2 represented by b. In contrast, a signal from the second port P2 represented by b toward the third port P3 represented by c is attenuated and absorbed by the terminating resistor 13, and a signal from the third port P3, represented by c, near the terminating resistor 13 toward the first port P1 represented by a is blocked.

Accordingly, when the isolator 1 is incorporated in the circuit shown in FIG. 4A, the effects described above can be achieved.

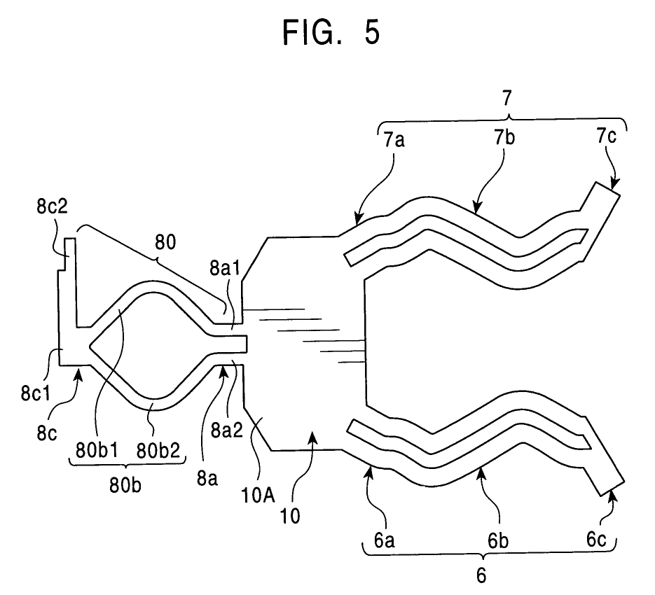

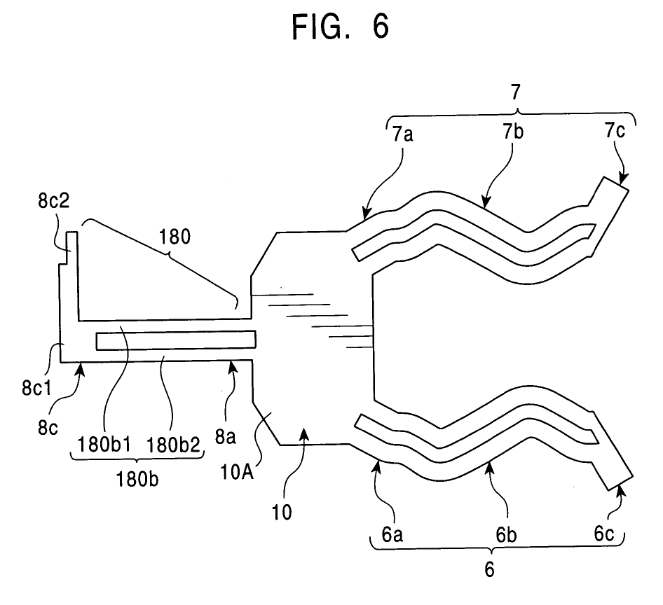

Although, in the isolator 1 according to the first embodiment, the third line conductor 8 of the electrode unit 16 constituting the magnetic assembly 15 has a shape shown in FIG. 3, the third line conductor 8 may have a shape shown in FIG. 5 or 6.

A third line conductor 80 shown in FIG. 5 is different from the third line conductor 8 shown in FIG. 3 in that a conductor segment 80b1 is not parallel to a conductor segment 80b2, and more specifically, that the conductor segments 80b1 and 80b2 protrude from conductor segments 8a1 and 8a2 in such a manner that the center of the conductor segments 80b1 and 80b2 diverge from each other and the conductor segments 80b1 and 80b2 constitute a diamond-shaped central conductor 80b.

A third line conductor 180 shown in FIG. 6 is different from the third line conductor 8 shown in FIG. 3 in that conductor segments 180b1 and 180b2 are straight when viewed in plan and the conductor segments 180b1 and 180b2 constitute a central conductor 180b. In this case, the third line conductor 180 can be easily folded over the plate-like magnetic material 5.

### Second Embodiment

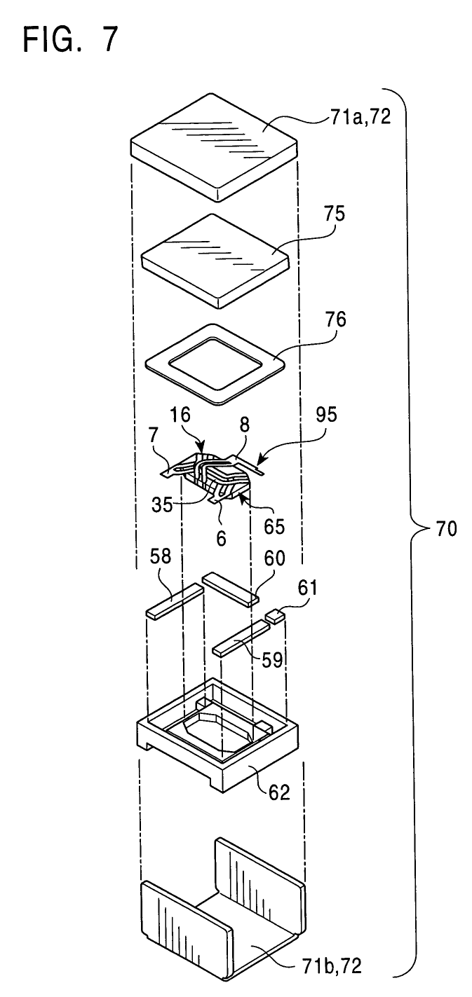

FIG. 7 shows a non-reciprocal circuit element applied to an isolator 70 according to a second embodiment of the present invention. The isolator 70 according to the second embodiment includes a hollow yoke 72 composed of an upper yoke 71a and a lower yoke 71b. A resin case 62 containing a magnetic member 75 made of a square plate permanent magnet, a spacing member 76, a magnetic assembly 95, matching capacitors 58, 59, and 60, and a terminating resistor 61 is accommodated in the hollow yoke 72, in other words, between the upper yoke 71a and the lower yoke 71b.

The magnetic assembly 95 includes the electrode unit 16 as in the first embodiment and a plate-like magnetic material 65 of an approximately rectangular shape when viewed in plan that is wrapped in the electrode unit 16. Although the plate-like magnetic material 65 has a shape approximately equal to that of the plate-like magnetic material 5 according to the first embodiment, which has a horizontally-long rectangular plate shape, the plate-like magnetic material 65 has a rectangular plate shape that is approximately square.

In the electrode unit 16 that wraps around the plate-like magnetic material 65, a front-end conductor of the first line conductor 6 is electrically connected to an electrode part (not shown) arranged at one end of the matching capacitor 59, a front-end conductor of the second line conductor 7 is electrically connected to an electrode part (not shown) arranged at one end of the matching capacitor 58, and a front-end conductor of the third line conductor 8 is electrically connected to the matching capacitor 60 and the terminating resistor 61. Accordingly, the plate-like magnetic material 65 is connected to the matching capacitors 58, 59, and 60 and the terminating resistor 61.

The isolator 70 with the arrangement shown in FIG. 7 achieves effects equal to that of the isolator 1 according to the first embodiment.

More detailed explanations about the present invention will be given by means of examples. However, the present invention is not limited to the following examples.

### EXAMPLE 1

A plate-like magnetic material made of YIG ferrite with a longer-side length of 3.55 mm, a shorter-side length of 2 mm, and a thickness of 0.35 mm was prepared. A magnetic assembly was produced by installing an electrode unit of a shape approximately equal to that shown in FIG. 3 on the plate-like magnetic material. The magnetic assembly was formed by the plate-like magnetic material, a first central conductor functioning as an input, an insulating sheet, a second central conductor functioning as an output, an insulating sheet, and a third central conductor that closely contacted each other in that order.

An isolator of Example 1 was produced by connecting the magnetic assembly to matching capacitors and a terminating resistor and by accommodating the magnetic assembly and a permanent magnet in a hollow yoke. The isolator was cubic with a length of 4 mm, a width of 4 mm, and a thickness of 1.6 mm. In other words, the isolator was a 4 mm square isolator.

### EXAMPLE 2

An isolator of Example 2 was produced as in Example 1, but the first central conductor closely contacted the plate-like magnetic material, and the insulating sheet was deposited on the first central conductor with a gap of 20 μm therebetween.

### EXAMPLE 3

An isolator of Example 3 was produced as in Example 1, but the second central conductor functioning as the output closely contacted the plate-like magnetic material, the insulating sheet was deposited on the second central conductor with a gap of 20 μm therebetween, and the insulating sheet, the first central conductor functioning as the input, the insulating sheet, and the third central conductor closely contacted each other in that order.

### EXAMPLE 4

An isolator of Example 4 was produced as in Example 1, but the first central conductor functioning as the input was deposited on the plate-like magnetic material, with a gap of 20 μm therebetween, with part of the first central conductor contacting the plate-like magnetic material, and the first central conductor, the insulating sheet, the second central conductor functioning as the output, the insulating sheet, and the third central conductor closely contacted each other in that order.

### EXAMPLE 5

An isolator of Example 5 was produced as in Example 1, but the second central conductor functioning as the output was deposited on the plate-like magnetic material, with a gap of 20 μm therebetween, with part of the second central conductor contacting the plate-like magnetic material, and the second central conductor, the insulating sheet, the first central conductor functioning as the input, the insulating sheet, and the third central conductor closely contacted each other in that order.

### EXAMPLE 6

A plate-like magnetic material made of YIG ferrite with a longer-side length of 4.44 mm, a shorter-side length of 2.5 mm, and a thickness of 0.438 mm was prepared. A magnetic assembly was produced by installing an electrode unit of a shape approximately equal to that shown in FIG. 3 on the plate-like magnetic material. The magnetic assembly was formed by the plate-like magnetic material, a first central conductor functioning as an input, an insulating sheet, a second central conductor functioning as an output, an insulating sheet, and a third central conductor that closely contacted each other in that order.

An isolator of Example 6 was produced by connecting the magnetic assembly to matching capacitors and a terminating resistor and by accommodating the magnetic assembly and a permanent magnet in a hollow yoke. The isolator was cubic with a length of 5 mm, a width of 5 mm, and a thickness of 2 mm. In other words, the isolator was a 5 mm square isolator.

### EXAMPLE 7

An isolator of Example 7 was produced as in Example 6, but the first central conductor closely contacted the plate-like magnetic material, and the insulating sheet was deposited on the first central conductor with a gap of 20 μm therebetween.

### EXAMPLE 8

An isolator of Example 8 was produced as in Example 6, but the second central conductor functioning as the output closely contacted the plate-like magnetic material, the insulating sheet was deposited on the second central conductor with a gap of 20 μm therebetween, and the insulating sheet, the first central conductor functioning as the input, the insulating sheet, and the third central conductor closely contacted each other in that order.

### EXAMPLE 9

An isolator of Example 9 was produced as in Example 6, but the first central conductor functioning as the input was deposited on the plate-like magnetic material, with a gap of 20 μm therebetween, with part of the first central conductor contacting the plate-like magnetic material, and the first central conductor, the insulating sheet, the second central conductor functioning as the output, the insulating sheet, and the third central conductor closely contacted each other in that order.

### EXAMPLE 10

An isolator of Example 10 was produced as in Example 6, but the second central conductor functioning as the output was deposited on the plate-like magnetic material, with a gap of 20 μm therebetween, with part of the second central conductor contacting the plate-like magnetic material, and the second central conductor, the insulating sheet, the first central conductor functioning as the input, the insulating sheet, and the third central conductor closely contacted each other in that order.

### Measurement of Input Impedance

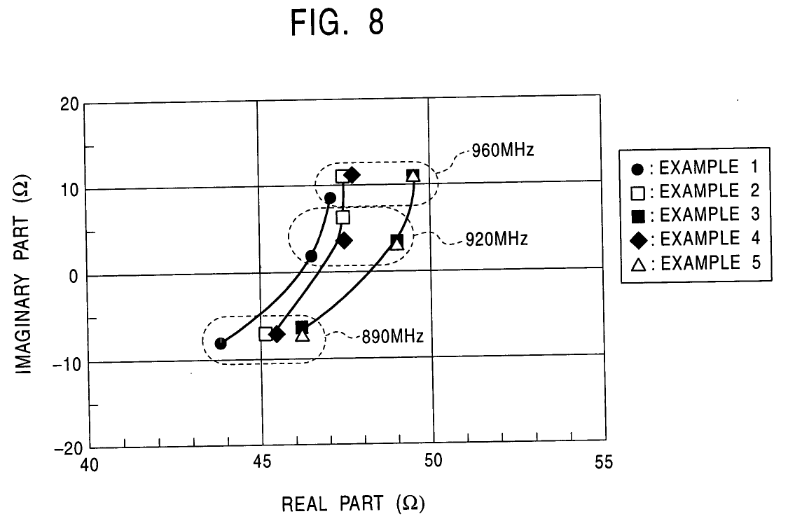

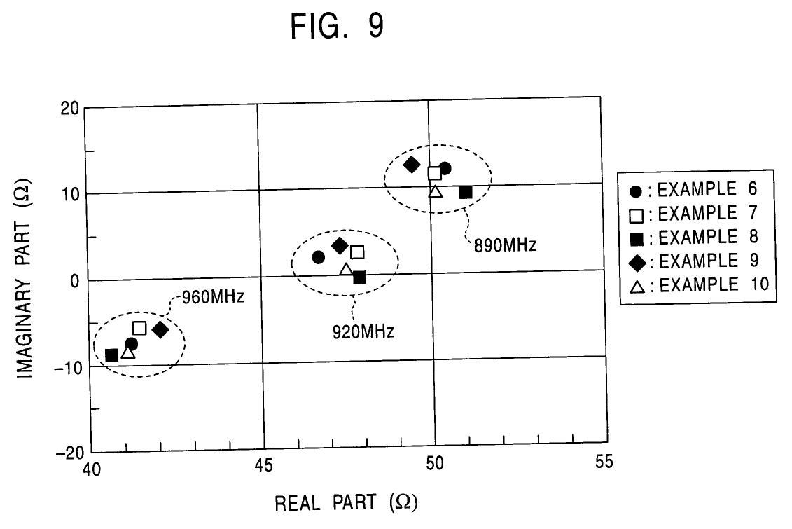

The input impedances of the isolators of Examples 1 to 10 were measured. The input impedances were measured at frequencies of 890 MHz, 920 MHz, and 960 MHz, and a real part and an imaginary part of the impedances were measured. FIG. 8 shows measurement results of Examples 1 to 5, and FIG. 9 shows measurement results of Examples 6 to 10. In FIGS. 8 and 9, the impedances at each frequency are plotted on a graph showing the real part on the horizontal axis and the imaginary part on the vertical axis.

### Measurement Results of Examples 1 to 5

As described above, in the isolator of Example 1, the plate-like magnetic material, the central conductors, and the insulating sheets closely contact each other. Thus, the isolator of Example 1 is a working example having the arrangement ideal for the present invention.

Also, the isolators of Examples 2 and 4 have an arrangement in which the first central conductor functioning as the input closely contacts or touches the plate-like magnetic material even with a gap between part of the first central conductor and the plate-like magnetic material. Thus, the isolators of Examples 2 and 4 are working examples having the arrangement according to the present invention.

In contrast, the isolators of Examples 3 and 5 have an arrangement in which the second central conductor functioning as the output closely contacts or is deposited on the plate-like magnetic material. Thus, the isolators of Examples 3 and 5 do not have an arrangement according to the present invention. Therefore, the isolators of Examples 3 and 5 are comparative examples.

Referring to FIG. 8, the results measured at the frequency of 890 MHz show that plots of Examples 1, 2, and 4 (working examples) are close to each other and that the input impedances of the isolators of Examples 1, 2, and 4 are approximately equal to each other in the real part and the imaginary part.

In contrast, the results measured at the frequency of 890 MHz also show that plots of Examples 3 and 5 (comparative examples) are approximately 2 Ω away in the horizontal axis direction from the plots of Examples 1, 2, and 4 (working examples) and that differences between the plots of Examples 3 and 5 and the plots of Examples 1, 2, and 4 are increased in the real part of the input impedances.

The results measured at the frequency of 960 MHz show that the plots of Examples 2 and 4 (working examples) are slightly farther in the horizontal axis direction from the plot of Example 1 (working example) as compared with the results measured at the frequency of 890 MHz. Thus, the results show that differences between the plot of Example 1 and the plots of Examples 2 and 4 are increased in the real part of the impedances.

The results measured at the frequency of 960 MHz also show that the plots of Examples 3 and 5 (comparative examples) are approximately 2 Ω away in the horizontal axis direction from the plot of Example 1 (working example) and that there is no big difference from the results measured at the frequency of 890 MHz.

Thus, especially at a lower frequency (890 MHz), there is a big difference between Examples 1, 2, and 4 (working examples) and Examples 3 and 5 (comparative examples) in the real part of the input impedances and thus there are variations in the input impedances.

Also, variations in the input impedances of the isolators of Examples 1, 2, and 4 (working examples) are reduced.

### Measurement Results of Examples 6 to 10

The isolators of Examples 6 to 10 include a hollow yoke of 5 mm square, which is one size larger than those of Examples 1 to 5.

Also, the isolators of Examples 6, 7, and 9 have an arrangement in which the first central conductor functioning as the input directly contacts or touches the plate-like magnetic material. The isolators of Examples 8 and 10 have an arrangement in which the second central conductor functioning as the output closely contacts or is deposited on the plate-like magnetic material.

Referring to FIG. 9, the results measured at the frequency of 890 MHz show that plots of Examples 6 to 10 are close to each other and that the input impedances of the isolators of Examples 6 to 10 are approximately equal to each other in the real part and the imaginary part of the input impedances even with different arrangements of isolators.

Similarly, the results measured at the frequencies of 920 MHz and 960 MHz show that the input impedances of the isolators of Examples 6 to 10 are approximately equal to each other in the real part and the imaginary part of the input impedances.

As described above, the structures of the isolators of Examples 6 to 10, which are 5 mm square isolators, have less influence on the input impedances than the structures of the isolators of Examples 1 to 5, which are 4 mm square isolators. Since the 5 mm square isolators include a plate-like magnetic material and central conductors that are one size larger than those of the 4 mm square isolators, the conductor lengths of the central conductors can be relatively increased and thus the inductances can be increased. Thus, even if the accuracy of mounting the central conductors on the plate-like magnetic material slightly varies, variations in inductances are compensated for and thus variations in the input impedance can be reduced.

In other words, since 4 mm square isolators have conductor lengths of central conductors smaller than those of 5 mm square isolators, the inductances thereof are smaller than those of the 5 mm square isolators. Thus, variation in the accuracy of mounting the central conductors on the plate-like magnetic material directly affects variations in the inductances. The tendency of variation in the inductances is increased in accordance with a reduction in the size of the isolators. Thus, the isolators of 4 mm square or less need high accuracy of mounting the first central conductor functioning as the input on the plate-like magnetic material. In order to increase the mounting accuracy, it is most desirable that the isolators have the arrangement according to the present invention in which the first central conductor directly contacts the plate-like magnetic material.

As described above, with the arrangement according to the present invention, a miniature isolator, such as 4 mm square or less, with little variation in the input impedance can be achieved.

What is claimed is:

1. A non-reciprocal circuit element in which a common electrode is disposed on one surface of a plate-like magnetic material, three central conductors protruding in respective directions from the periphery of the common electrode are folded over the other surface of the plate-like magnetic material so as to wrap around the plate-like magnetic material, and the central conductors cross each other at a predetermined angle on the other surface of the plate-like magnetic material, wherein
one of the central conductors that functions as an input is disposed in a position closer to the other surface of the plate-like magnetic material as compared with the other central conductors and directly contacts the plate-like magnetic material.

2. A non-reciprocal circuit element according to claim 1, wherein the central conductor functioning as the input closely contacts the other surface of the plate-like magnetic material.

3. A non-reciprocal circuit element according to claim 1, wherein the plate-like magnetic material, the common electrode, and the central conductors are contained in a hollow yoke of an approximately rectangular parallelepiped made of soft magnetic materials, and at least two sides defining the hollow yoke are each 4 mm or less.

4. A non-reciprocal circuit element according to claim 1, wherein one of the central conductors that functions as an output is disposed on the central conductor functioning as the input on the other surface of the plate-like magnetic material.

5. A non-reciprocal circuit element according to claim 1, wherein a length of an overlap portion of the central conductor functioning as the input and the central conductor functioning as the output in an intersection of the central conductor functioning as the input and the central conductor functioning as the output is 10% or more of a length of portions of the central conductors disposed on the other surface of the plate-like magnetic material.

6. A non-reciprocal circuit element according to claim 1, wherein the central conductor functioning as the input and the central conductor functioning as the output are connected to a matching capacitor and the other central conductor is connected to a matching capacitor and a terminating resistor.

7. A communication apparatus comprising:
the non-reciprocal circuit element as set forth in claim 1;
a transmitting circuit part connected to the central conductor functioning as the input of the non-reciprocal circuit element; and
an antenna connected to the central conductor functioning as the output of the non-reciprocal circuit element.

8. A communication apparatus comprising:
the non-reciprocal circuit element as set forth in claim 2;
a transmitting circuit part connected to the central conductor functioning as the input of the non-reciprocal circuit element; and
an antenna connected to the central conductor functioning as the output of the non-reciprocal circuit element.

9. A communication apparatus comprising:
the non-reciprocal circuit element as set forth in claim 3;
a transmitting circuit part connected to the central conductor functioning as the input of the non-reciprocal circuit element; and
an antenna connected to the central conductor functioning as the output of the non-reciprocal circuit element.

10. A communication apparatus comprising:
the non-reciprocal circuit element as set forth in claim 4;
a transmitting circuit part connected to the central conductor functioning as the input of the non-reciprocal circuit element; and
an antenna connected to the central conductor functioning as the output of the non-reciprocal circuit element.

11. A communication apparatus comprising:
the non-reciprocal circuit element as set forth in claim 5;
a transmitting circuit part connected to the central conductor functioning as the input of the non-reciprocal circuit element; and
an antenna connected to the central conductor functioning as the output of the non-reciprocal circuit element.

12. A communication apparatus comprising:
the non-reciprocal circuit element as set forth in claim 6;
a transmitting circuit part connected to the central conductor functioning as the input of the non-reciprocal circuit element; and
an antenna connected to the central conductor functioning as the output of the non-reciprocal circuit element.
